(19) United States
(12) Patent Application Publication
(10) Pub. No.: US 2017/0273144 A1
(43) Pub. Date: Sep. 21, 2017

(54) ELECTRIC HEATING CIRCUIT AND HEATING ELEMENT FOR A WINDSCREEN WIPER BLADE, METHOD FOR THE MANUFACTURE OF A HEATING ELEMENT, AND WINDSCREEN WIPER BLADE

(71) Applicant: Valeo Systèmes d'Essuyage, Le Mesnil Saint Denis (FR)

(72) Inventors: Gérald Caillot, Cernay La Ville (FR); Jean-Michel Jarasson, Le Mesnil Saint Denis (FR); Vincent Izabel, Chilly Mazarin (FR); Clementine Derrepas, Le Mesnil Saint Denis (FR)

(73) Assignee: Valeo Systèmes d'Essuyage, Le Mesnil Saint Denis (FR)

(21) Appl. No.: 15/464,477

(22) Filed: Mar. 21, 2017

(30) Foreign Application Priority Data
Mar. 21, 2016 (FR) 1652400

(51) Int. Cl. H05B 3/14; B60S 1/38

(52) U.S. Cl. CPC H05B 3/146; B60S 1/3805; H05B 2203/02; H05B 2214/02

(57) ABSTRACT

The invention proposes a heating element (30) incorporating an electric heating circuit for a windscreen wiper blade on a motor vehicle, comprising at least one resistive heating element (36) which is connected to the electric power supply terminals (40) of said heating element, characterized in that at least one resistive heating element is a PTC resistive heating element (36), formed by the application of a resistive ink with a positive temperature coefficient.

### TECHNICAL FIELD OF THE INVENTION

The invention relates to an electric heating circuit for a windscreen wiper blade on a vehicle.

The invention also relates to an electric heating element comprising an electric heating circuit, a windscreen wiper blade comprising a heating element, and a method for the manufacture of an electric heating element.

### TECHNICAL BACKGROUND OF THE INVENTION

In a known manner, it is possible to heat a windscreen wiper blade on a vehicle, specifically for the de-icing thereof in winter or, moreover, for the exploitation of the heat produced by the heating means for the de-icing of the exterior surface of the windscreen which is to be cleaned by the windscreen wiper.

Where the windscreen wiper blade incorporates internal channels for the distribution of a windscreen washer fluid, heating of the windscreen wiper blade can also permit the heating of the windscreen washer fluid prior to the spraying or projection thereof onto the exterior surface of the windscreen, thereby further facilitating operations for the de-icing of the windscreen, and potentially eliminating the use of a manual scraper.

In a known manner, a windscreen wiper blade of the “flat blade” type comprises a longitudinal body which carries a wiper blade, generally of natural or synthetic rubber construction, which is designed to rub against the exterior surface of the glazing to be wiped, for example the windscreen of a motor vehicle, for the removal of water therefrom and the routing of said water beyond the field of vision of the driver.

A windscreen wiper blade of this type also comprises at least one longitudinal rib, which confers a curvature upon the wiper blade which is conducive to the application thereof to the outer surface of the glazing.

The windscreen wiper blade is carried on a windscreen wiper arm or drive arm, which is driven in a reciprocating motion by an electric drive motor.

Means for the connection of the windscreen wiper blade to the drive arm may comprise a connector, which is integral to the longitudinal body, and an adaptor which is fitted to the longitudinal body in a pivoting arrangement, and is secured to one free end of the arm.

In a known manner, the heating means employ an electric heating circuit comprising at least one electric heating resistor which, when supplied with electric current, generates heat which is dissipated into its surroundings.

For example, it has already been proposed that the curving rib of a windscreen wiper blade should be equipped with heating means configured as a press-on film for adhesion to at least one of the two opposing flat surfaces of the rib, and incorporating an electric heating circuit.

The electric heating circuit is, for example, a loop of an electrically-conductive wire, the ends of which are connected to electric power supply terminals.

In the case of a “high-end” vehicle, the control and protection of the windscreen wiper blade heating function is generally executed directly by means of the electronics and the electric circuit of the vehicle. In this case, the heating control function needs to be integrated in the general definition of the electrical architecture of the vehicle, thereby generating an element of cost.

In the case of a “mid-range” or “budget” vehicle, the manufacturer may wish to exclude any modification to the vehicle architecture, and will then request an option for the direct integration of the control and protection function into the heated windscreen wiper blade itself.

It may also be desired to equip an existing vehicle with a windscreen wiper blade heating function, whereas the vehicle has been designed and marketed with no such function, and consequently with no means for the control of the heating function.

Accordingly, other functions of the vehicle are not affected in the event of an impaired operating mode, for example in case of the supply of incorrect information by an exterior temperature or vehicle speed sensor, or in case of the failure of such a sensor.

In a known manner, the heating function is generally tripped in response to an exterior temperature below 5° C., in order to ensure the complete de-icing of the windscreen wiper blade, including the de-icing of distribution channels, of means for the connection of the windscreen wiper blade to the wiper arm, or of the wiper blade in contact with the outer surface of the glazing.

In impaired mode, for example in case of the failure of an exterior temperature or vehicle speed sensor, which delivers information according to which the vehicle is in motion, whereas it is actually stationary, there is a risk of the continuous heating of the windscreen wiper blade above and beyond 5° C., for example in mid-summer at ambient temperatures exceeding 30° C. Such a situation may result in the formation of a hot spot, a short-circuit, physical deterioration of the windscreen wiper blade or, in a worst-case scenario, an incipient fire.

The invention is intended to propose a simple, efficient and cost-effective solution to the inherent design problems associated with the prior art, without recourse to dedicated means for the thermal protection of the windscreen wiper blade.

### BRIEF SUMMARY OF THE INVENTION

The invention proposes an electric heating circuit for a windscreen wiper blade on a vehicle, specifically a motor vehicle, comprising at least one resistive heating element which is connected to the electric power supply terminals of said element, characterized in that at least one resistive heating element is a PTC resistive heating element, formed by the application of a resistive ink with a positive temperature coefficient.

The acronym PTC stands for “positive temperature coefficient”, and designates an intrinsic characteristic of the material selected, in this case a “PTC” ink with a positive temperature coefficient.

Accordingly, a PTC resistive heating element has an electrical resistance which increases as the temperature rises.

A PTC resistive heating element of this type is distinguished from other nesting elements, the electrical resistance of which is substantially constant, in that a PTC resistive heating element is independently capable of controlling its temperature by the regulation of the heating capacity delivered via its electrical resistance, in response to temperature. At a low temperature, its resistance is lower, and its heating capacity is therefore higher, specifically permitting a rapid increase in temperature. As the temperature rises, the resistance of the PTC resistive heating element increases, thereby resulting in a reduction in its heating capacity.

During a short period, and at certain temperatures, the heating capacity of the PTC resistive heating element may reduce to the point where it simply offsets the energy loss in the system, thus maintaining a constant value.

Accordingly, without the employment of specific control means—such as an electronic circuit with pulse-width modulation (or PWM circuit)—the integration of the electric heating circuit according to the invention into one of the components of the windscreen wiper blade permits self-regulation of the heating function and executes a safety function, specifically for the prevention of any deterioration of the windscreen wiper blade.

The design according to the invention, which employs PTC resistive heating elements produced by the deposition of a PTC ink, is advantageous in respect of its compactness, its ease of integration and its ease of deployment.

According to further characteristics of the electric heating circuit:
it comprises a plurality of PTC resistive heating elements which are connected to the same electric power supply terminals;
it comprises a plurality of PTC resistive heating elements which are connected in parallel to the same electric power supply terminals;
it comprises two electrical conductors for the connection of each PTC resistive heating element to the electric power supply terminals;
each connecting electrical conductor is formed by an electrically-conductive ink;
each connecting electrical conductor is a strip of electrically-conductive ink; the two strips of electrically-conductive ink are arranged in parallel; each resistive heating element is a block of resistive ink with a positive temperature coefficient, which is arranged transversely to bridge the two strips of electrically-conductive ink;
the heating circuit comprises;
   a portion comprising a plurality of PTC resistive heating elements, forming a first heating and control resistor; and
   a further portion forming a second heating resistor, arranged in series with the first resistor.

The invention also proposes a heating element for a windscreen wiper blade on a vehicle, specifically a motor vehicle, characterized in that it comprises a support and at least one electric heating circuit according to the invention, which is carried by the support.

According to further characteristics of the heating Element:
the support is a rib, for stiffening and/or curvature of a windscreen wiper blade, and at least one of the opposing sides of the rib carries, whether directly or indirectly, at least one PTC resistive heating element;
the rib carries, whether directly or indirectly, at least one PTC resistive heating element on each of its two opposing sides;
the heating element incorporates an electrically-insulating layer, interposed between the support and each PTC resistive heating element;
the support is a wiper blade of a windscreen wiper, which is designed to rub against the glazing to be wiped;
the support is a deflector of a windscreen wiper, which is designed to improve the aerodynamic performance of the windscreen wiper;
the support is a flexible substrate, thus permitting the production of the heating element in the form of a heating film;
the support is formed of an electrically-conductive material, or of a non-electrically-conductive material.

The invention moreover proposes a windscreen wiper blade for a motor vehicle, characterized in that it comprises at least one heating element according to the invention.

According to a further characteristic of the windscreen wiper blade, the latter incorporates means of connection or adaptation to a windscreen wiper drive arm, wherein said means of connection comprises means of electrical connection to the aforementioned electric power supply terminals.

Finally, the invention proposes a method for the manufacture of an electric heating element for a windscreen wiper blade on a vehicle, specifically a motor vehicle, wherein said element comprises:
at least one electric heating circuit comprising at least one PTC resistive heating element with a positive temperature coefficient, which is connected to the electric power supply terminals of the element; and
a support for said PTC resistive heating element, characterized in that it comprises at least one step a) for the formation of each PTC resistive heating element by the deposition on the support of a resistive ink with a positive temperature coefficient.

According to further characteristics of the method;
step a) is preceded by a step b) for the deposition of an electrically-insulating layer on the support;
the method for the manufacture of an electrical heating element comprising two electrical conductors for the connection of each PTC resistive heating element to the electric power supply terminals is characterized in that step a) is preceded by a step c) for the formation of each electrical conductor by the deposition of an electrically-conductive ink on the support;
said step a) or c) for the deposition of an ink is executed by screen printing;
the support is formed of an electrically-conductive or of a non-electrically-conductive material;
the method comprises a step d) for the coverage of at least part of the electric heating circuit with at least one electrically-insulating protective layer.

### BRIEF DESCRIPTION OF THE FIGURES

Further characteristics and advantages of the invention can be identified from the detailed description provided hereinafter, which is non-limiting and is provided for the purposes of clarification, with reference to the attached drawings, in which:

FIG. 1 shows an exploded perspective view of a windscreen wiper blade for a motor vehicle;

FIG. 2 shows a schematic overhead view of an illustrative example of the embodiment of a heating element according to the invention, configured here in the form of a heating film which is designed for application to one side of the curving rib of the windscreen wiper blade in FIG. 1;

FIG. 3 shows a cross-sectional view, in the longitudinal and vertical plane along the line 3-3, of a section of the heating element represented in FIG. 2.

### DETAILED DESCRIPTION OF THE FIGURES

In the description hereinafter, elements of identical structure or of comparable function are identified by the same reference numbers.

In the description hereinafter, in a non-limiting manner, the longitudinal, vertical and transverse orientations considered are those indicated by the trihedron “L, V, T” in the figures. A horizontal plane, which extends longitudinally and transversely, is thus defined.

The longitudinal orientation or direction corresponds to the main axis of the windscreen wiper blade.

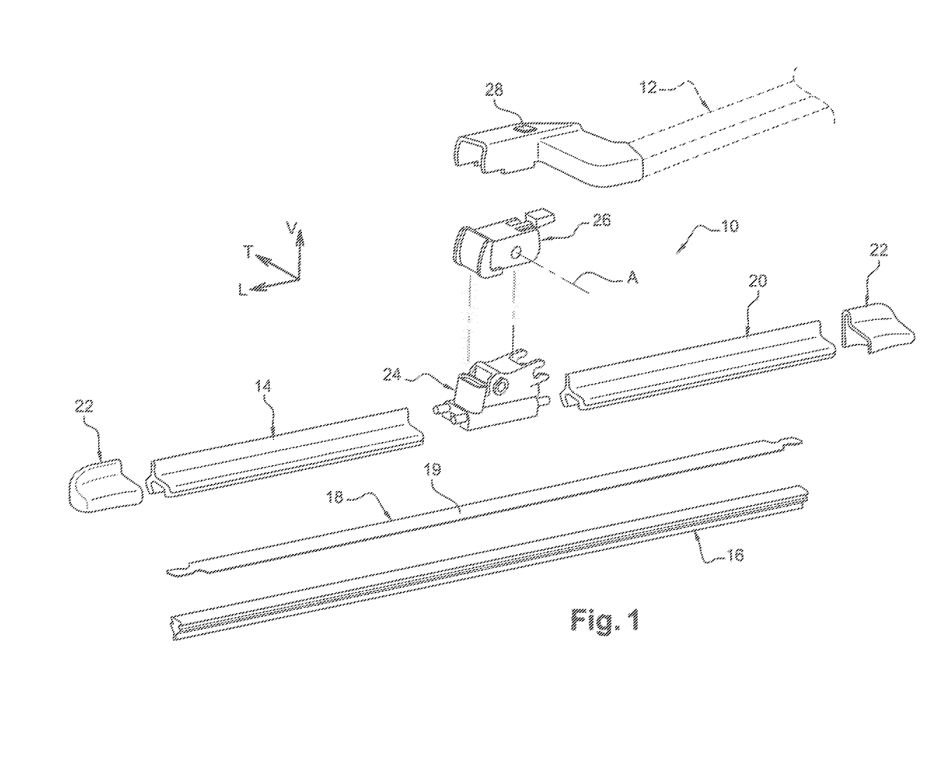

FIG. 1 represents a windscreen wiper blade 10, for example for the wiping of the exterior surface of the windscreen of a motor vehicle.

Also partially represented is a drive arm 12 for the windscreen wiper blade 10, which is itself designed to be driven by an electric motor (not represented), such that the windscreen wiper blade describes a reciprocating angular motion for the removal of water and, where applicable, of other unwanted items, from the exterior surface of the windscreen.

The windscreen wiper blade 10 comprises a longitudinal body 14, a wiper blade 16 and at least one rib 18, the function of which is the conferral of a curvature upon the wiper blade 16 which is conducive to the application of the wiper blade 16 to the exterior surface of the windscreen, in accordance with the three-dimensional geometrical configuration of said exterior surface.

In this case, the longitudinal body 14 of the windscreen wiper blade 10 comprises an upper deflector 20, which is designed to improve the operation of the windscreen wiper blade, wherein the function of the deflector 20 is the improvement of the contouring of the wiper blade 16 to the exterior surface of the windscreen, thus improving the aerodynamic performance of the entire windscreen wiper system.

The windscreen wiper blade 10 moreover comprises end caps or clips 22 for the attachment of the wiper blade 16 and the rib 18 to the longitudinal body 14 wherein, in this case, the clips 22 are located at each of the two opposing longitudinal ends of the longitudinal body 14.

In this case, the longitudinal body 14 of the windscreen wiper blade 10 is formed of two separate sections, which are mutually configured in a substantially end-to-end arrangement, and are interconnected by means of an intermediate connector 24.

For the fitting of the windscreen wiper blade 10 to the windscreen wiper arm 12, the blade 10 comprises an adaptor 26 which is fitted to the intermediate connector 24, and which permits the articulation of the windscreen wiper blade 10 in relation to the arm 12.

The articulation or the windscreen wiper blade 10 in relation to the windscreen wiper arm 12 is an articulation described by a pivoting motion around a pivoting axis A of transverse orthogonal orientation to the longitudinal axis of the windscreen wiper blade 10.

In practice, the windscreen wiper blade 10 must have at least a degree of freedom for rotation or pivoting in relation to the windscreen wiper arm 12 and, more specifically, in relation to a terminal or distal component 28 fitted to the free end of the drive arm 12, in order to permit the windscreen wiper blade 10 to follow the spatial curvature of the exterior surface of the windscreen.

According to the invention, the windscreen wiper blade 10 is equipped with a heating element, or heater element, which is essentially comprised of a support and components for the execution of an electrical heating resistance function, which are carried by the support, wherein the heating element is incorporated in the windscreen wiper blade 10 and, in the design illustrated in the figures, is designed for fitting to one surface of a rib 18, for example the upper surface 19.

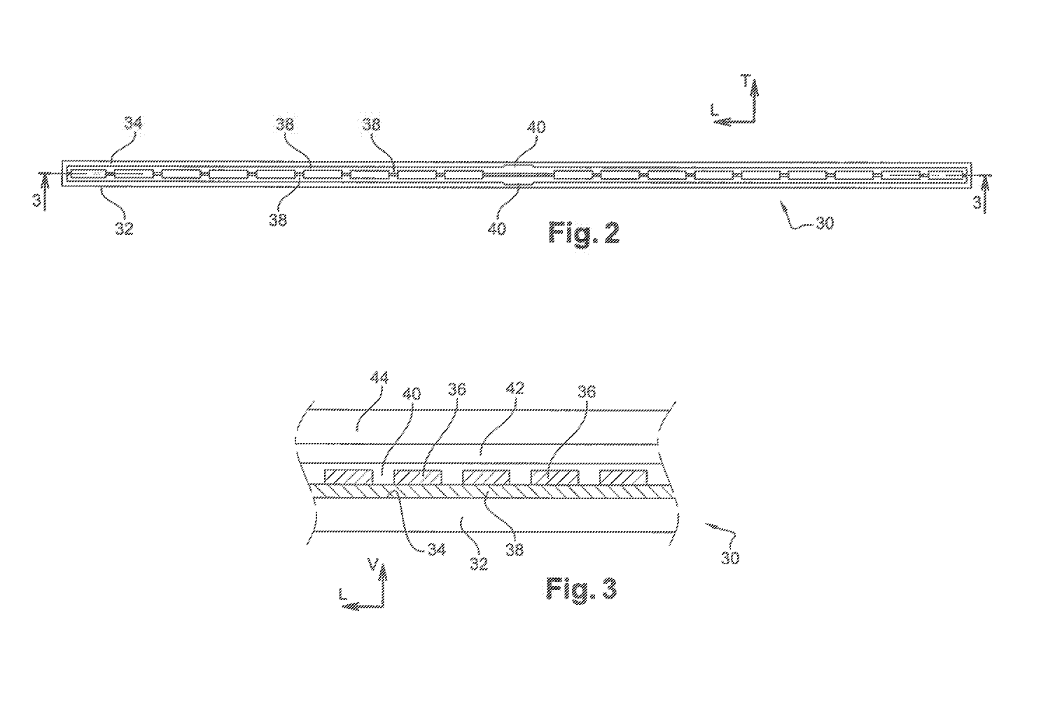

As can specifically be seen from FIG. 2, the heating element 30 according to the invention is configured here in the form of a heating film, which is designed for fitting to one surface 19 of the curving rib 18.

The heating film 30 comprises a lower substrate 32 formed of a non-electrically-conductive material, in this case of a generally rectangular shape, the dimensions, length and width whereof permit the adaptation and fitting of the heating film 30 to a curving rib 18 of specific dimensions.

The substrate 32 is, for example, a film of a flexible plastic or synthetic material, the composition of which is detailed hereinafter.

The substrate 32 may comprise, on its lower surface which is designed to cooperate with an element of the windscreen wiper blade (for example, with the upper surface 19 of the rib 18), an adhesive coating which permits the attachment of the heating film 30 by the adhesive bonding of said adhesive coating, for the example to the rib 18.

The substrate 32 comprises an exposed upper surface 34 on which an electric heating circuit is formed in accordance with the instruction of the invention and which, in the present exemplary embodiment, is comprised solely of PTC resistive heating elements.

In this case, each PTC resistive heating element is a block 36 of ink with a positive temperature coefficient.

Each PTC block 36 is rectangular in shape, and said blocks 36 are eighteen in number, aligned longitudinally and juxtaposed in an adjoining manner, with the exception of the central or median part of the length of the heating element 30 which, in this case, is a zone which is clear of PTC resistive heating elements. Accordingly, in the example illustrated in FIG. 2, the electric heating circuit comprises two groups, each consisting of nine resistive heating elements 36.

The number of resistive heating elements may naturally be subject to variation, specifically as a function of the length of the windscreen wiper blade and consequently, for example, the length of the rib, and may be distributed evenly or otherwise over said length.

For the electrical connection of each PTC block 36 to an electric power source, the heating element 30 in this case comprises, by way of an example, two parallel electrical conductors 38, each configured in the form of a longitudinal strip which substantially extends over the full length of the heating element 30.

In an exemplary embodiment, each electrically-conductive strip 38 is formed by the deposition of a conductive ink, for example with a silver (Ag) base, upon the upper surface 34 of the substrate 32.

In the central part of the heating element 30, i.e. the zone which features no PTC resistive heating elements, each electrically-conductive strip 38 incorporates a transversely-expanded central portion 40, which forms an electrical connection terminal for the corresponding strip 38.

The median zone in which the connection terminals 40 are located can, for example, correspond to the longitudinal position of the connector 24 of the windscreen wiper blade on the curving rib 18.

In a known manner, the connector 24 can incorporate means for electrical connection (not represented) which are designed to engage with the electrical connection terminals 40 on the heating element 30 which is fitted to the curving rib 18.

Moreover, the bonding or electrical connection of the electrical connection terminals 40 to an electric power supply source (not represented) on the vehicle is then effected in a known manner, for example via an adaptor 26 and thereafter the windscreen wiper arm 30.

All the resistive heating elements or blocks 36 are connected to the same electric power supply terminals 40, in this case in a parallel arrangement.

To this end, each resistive heating element 36 is configured to extend transversely, in a bridging arrangement, across each of the electrically-conductive strips 38.

Each electrically conductive strip 38 thus constitutes an “electrical connector bar” or “busbar”.

The formation of the electrically-conductive strips 38 using a conductive ink, and of the PTC resistive heating elements 36 using a PTC ink, is executed, for example, by deposition using a screen printing method.

This method for the deposition of successive layers of ink is effected, for example, firstly by the execution of a step for the deposition of the electrically-conductive strips 38, and thereafter by the execution of a step for the deposition of PTC resistive heating elements 36.

In an unrepresented variant, it is possible to firstly proceed with the deposition of the PTC resistive heating elements 36, and thereafter with the deposition of ink to form the electrically-conductive strips 38.

FIG. 2 shows a schematic representation—to a large scale, and with no consideration of the relative dimensions of the various components—of a section of the heating element.

The lower substrate 32 is formed, for example, of polyethylene (PET).

Further to the formation, by deposition, of the electrically-conductive strips 38 and of the PTC resistive heating elements 36, it is possible to cover this combination successively with a protective layer 41, thereafter with a laminated adhesive layer 42 and finally, again by way of an example, with an upper “substrate” 44 of analogous design to the lower substrate 32.

By way of an example, the PTC resistive heating elements 36 can be formed by the screen-print deposition of an ink with a positive temperature coefficient, of the type marketed by the company “Henkel” (registered trademark) under the reference LOCTITE ECI 8000 (registered trademark), or by the company “Du Pont” (registered trademark) under the reference “7292”.

The principle of thermal self-regulation, or the principle of protection against the effects of accidental overheating, is based upon the principle of Ohm's law, according to which U=R*I and P=I*U=R*I², where U is the electric supply voltage, I is the current intensity, R is the resistance value and P is the power supplied.

The heating element 30 of the PTC type can also be considered as an “intelligent” heating element, wherein its initial resistance R0 is expressed in ohms per unit of surface (area).

As a function of the application, and the overall heating effect desired, the effective electrical resistance W of a heating element 30 can be obtained by determining a given number of resistive heating elements 36, and the arrangement thereof according to a specific pattern of electrical connection(s).

Where N is the number of PTC elements 36, the total heating capacity is a function of N*U²/R0, and can easily be adapted by the selection of any parameter, such as the voltage applied, the total number of PTC blocks 36 arranged in parallel, and their initial resistance(s) R0.

According to an unrepresented variant, the heating element can be configured “directly” on the curving rib 18, wherein the latter thus constitutes, within the meaning of the invention, the support for the electric heating circuit.

To this end, the upper surface 19 thus assumes the role of the upper surface 34 of the substrate 32.

If the curving rib 18 is formed of metal, in order to benefit advantageously from the substantial resulting effect of thermal radiation, it is then necessary—specifically prior to the deposition of an electrically-conductive ink for the formation of the electrically-conductive strips 38—to coat the upper surface 19 with a non-electrically-conductive layer.

Naturally, if the curving rib 18 itself is formed of a non-electrically-conductive material, it may then not be necessary to arrange the deposition of a layer of non-electrically-conductive material between the upper surface 19 and the electrically-conductive strips 38.

The aforementioned techniques for the deposition of successive layers of inks, for example by screen printing, can naturally be employed if the rib 18 itself constitutes the support within the meaning of the invention.

According to an unrepresented variant, the support may be comprised of a portion of the surface of the wiper blade 16 or of the aerodynamic deflector 20.

Likewise, where the heating element is configured in the form of a separate heating film, which can be applied to an element or component of the windscreen wiper blade, the heating element can be secured by adhesive bonding to a portion of the surface of the wiper blade 16, or to a portion of the surface of the aerodynamic deflector 20.

A heating circuit according to the invention is not necessarily comprised, in its totality, of resistive heating elements of the PTC type.

In practice, the electric heating circuit can comprise a first portion, or first section, consisting of a plurality of PTC resistive heating elements 36 as described above—which then form a first heating and control resistor of rating R1—and a second portion, or second section, which is configured for example as a “conventional” electric heating resistor, which is arranged in series with the first portion, and of rating R2.

The total heating capacity is thus equal to U²/(R1+R2). Accordingly, beyond a predetermined temperature threshold, the resistance R1 of the first portion of the electric heating circuit increases rapidly, thereby resulting in the reduction or stabilization of the heating capacity, and consequently of heating.

The variant also permits the self-regulation of the heating element around a specific threshold value.

1. An electric heating circuit for a windscreen wiper blade on a motor vehicle, comprising:
at least one resistive heating element which is connected to the electric power supply terminals of said element,
wherein the at least one resistive heating element is a PTC resistive heating element, formed by the application of a resistive ink with a positive temperature coefficient.

2. The electric heating circuit according to claim 1, further comprising a plurality of PTC resistive heating elements which are connected to the same electric power supply terminals.

3. The electric heating circuit according to claim 2, further comprising the plurality of PTC resistive heating elements which are connected in parallel to the same electric power supply terminals.

4. The electric heating circuit according to claim 2, further comprising two electrical conductors for the connection of each PTC resistive heating element to the electric power supply terminals.

5. The electric heating circuit according to claim 4, wherein each connecting electrical conductor is formed by an electrically-conductive ink.

6. The electric heating circuit according to claim 5, wherein:
each connecting electrical conductor is a strip of electrically-conductive ink;
the two strips of electrically-conductive ink are arranged in parallel; and
each PTC resistive heating element is a block of resistive ink with a positive temperature coefficient, which is arranged transversely to bridge the two strips of electrically-conductive ink.

7. The electric heating circuit according to claim 1, further comprising:
a portion comprising a plurality of PTC resistive heating elements, forming a first heating and control resistor; and
a further portion forming a second heating resistor, arranged in series with the first resistor.

8. A heating element for a windscreen wiper blade on a motor vehicle, comprising:
a support; and
at least one electric heating circuit according to claim 1, which is carried by the support.

9. The heating element according to claim 8, wherein the rib, for stiffening or curvature of a windscreen wiper blade, and at least one of opposing sides of the rib carries, directly or indirectly, at least one PTC resistive heating element.

10. The heating element according to claim 8, wherein the rib carries, directly or indirectly, at least one PTC resistive heating element on each of two opposing sides.

11. The heating element according to claim 8, further comprising an electrically-insulating layer interposed between the support and each PTC resistive heating element.

12. The heating element according to claim 8, wherein that the support is a wiper blade of a windscreen wiper configured to rub against a glazing to be wiped.

13. The heating element according to claim 8, wherein the support is a deflector of a windscreen wiper configured to improve the aerodynamic performance of the windscreen wiper.

14. The heating element according to claim 8, wherein the support is a flexible substrate, thus permitting the production of the heating element in the form of a heating film.

15. An windscreen wiper blade for a motor vehicle, comprising at least one heating element according to claim 8.

16. The windscreen wiper blade according to claim 15, further comprising means of connection to a windscreen wiper drive arm, wherein said means of connection comprises means of electrical connection to the electric power supply terminals.

17. A method for the manufacture of an electric heating element for a windscreen wiper blade on a motor vehicle, wherein said heating element comprises:
at least one electric heating circuit comprising at least one PTC resistive heating element with a positive temperature coefficient, which is connected to electric power supply terminals of the element; and
a support for said PTC resistive heating element,
the method comprising:
at least one step a) for formation of each PTC resistive heating element by depositing a resistive ink with a positive temperature coefficient on the support.

18. The method according to claim 17, characterized in that step a) is preceded by a step b) of depositing an electrically-insulating layer on the support.

19. The method according to claim 17 for the manufacture of an electric heating element comprising two electrical conductors for the connection of each PTC resistive heating element to the electric power supply terminals, wherein step a) is preceded by a step c) for the formation of each electrical conductor by depositing an electrically-conductive ink on the support.

20. The method according to claim 19, wherein step a) or c) of depositing the ink is executed by screen printing.

21. The method according to claim 17, wherein the support is formed of an electrically-conductive or of a non-electrically-conductive material.

22. The method according to claim 17, further comprising a step d) of covering at least part of the electric heating circuit with at least one electrically-insulating protective layer.
